(19) United States
(12) Patent Application Publication
(10) Pub. No.: US 2007/0169083 A1
(43) Pub. Date: Jul. 19, 2007

(54) Method for secure in-service software upgrades

(76) Inventors: Shyam P. Penubolu, Hyderabad (IN); Kevin J. Smith, North Attleboro, MA (US)

Correspondence Address: MOTOROLA, INC., LAW DEPARTMENT, 1303 E. ALGONQUIN ROAD, SCHAUMBURG, IL, 60196, US

(21) Appl. No.: 11/299,514

(22) Filed: Dec. 12, 2005

(51) Int. Cl. G06F 9/44

(52) U.S. Cl. 717/168

(57) ABSTRACT

A method for upgrading software without vulnerability to faults includes having a first node with a first component having a first version of a software program in an active mode and a second node with a second component having a first version of the software program in a standby mode. To upgrade the components, a third component with a second version of the software program is installed in a standby mode on the second node, synchronizes with the first component, and switches modes with the first component. The second component is deleted. A fourth component with a second version of the software is installed on the first node in a standby mode, synchronizes states with the third component. The first component is then deleted.

### FIELD OF THE INVENTION

The present invention relates generally to upgrading software, and more particularly relates to removing vulnerability to faults while performing in-service software upgrades.

### BACKGROUND OF THE INVENTION

Programs are sets of software instructions that perform together to control a variety of functions in many different areas of a processing system. Computer programs which are initially installed and configured on one or more storage devices in the system at start up typically control continuously operating computer systems. It is frequently necessary or desirable to update, change, or replace one or more components of the system software. For instance, it may be desirable to provide additional features to the system; occasionally, it is necessary to solve problems or “bugs” which have been found during operation of the system; and frequently it is desirable to update software programs to accommodate new developments in technology.

When a software change is to be made, typically, a new version of the software code is installed and configured on the system. Shutting down system operations, in whole or in part, to install the new software, leads to financial and service losses due to the downtime involved. To avoid interruption of the continuously-running components within the system, methods have been developed to allow software upgrades to occur while the system remains “in-service.”

These currently-utilized in-service software upgrade procedures require, at a minimum, a two-node (2N) redundancy scheme. The 2N redundancy scheme places a first component on a first node and a second component on a second node, which is in communication with the first node. One of the components is actively running a system process while the other component is in a standby mode. While in the standby mode, the component does not process any requests but dynamically keeps track of configuration updates and state information so that, in case of a failure of the active component, the standby component is updated and available to immediately assume control of the system.

To accomplish the software upgrade, the conventional procedure is to first upgrade the non-active standby component to the new version. The standby component is then given time to synchronize state information with the active component. Once the components have synchronized, the components switch modes so that the original standby component, now upgraded to the new version of the software, becomes the active component and the previously active component becomes the current standby version. The new standby version (previously active version) is then upgraded to the new version of the software. Finally, the components synchronize again and switch modes with each other. The originally active component is now updated and active.

However, the currently prevalent in-service software upgrade schemes are typically vulnerable to faults. This is especially true during the step of upgrading the standby component and the step of synchronizing the standby component with the active component. During these times, if the active component goes down, the standby component either is not fully upgraded and able to operate, or is not fully synchronized with state information.

Therefore a need exists to overcome the problems with the prior art as discussed above.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of a computer network according to an embodiment of the present invention.

FIG. 2 is a block diagram illustrating a first system state with a first active component and a second standby component, both being a first version of a software program, according to an embodiment of the present invention.

FIG. 3 is a block diagram illustrating a second system state with a first active component and a second standby component, both being a first version of a software program, and a third standby component being of a second version of a software program, according to an embodiment of the present invention.

FIG. 4 is a block diagram illustrating a third system state with a first standby component and a second standby component, both being a first version of a software program, and a third active component being of a second version of a software program, according to an embodiment of the present invention.

FIG. 5 is a block diagram illustrating a fourth system state with a first standby component with a first version of a software program, a second standby component with first version of a software program, and a third active component with a second version of a software program, according to an embodiment of the present invention.

FIG. 6 is a block diagram illustrating a fifth system state with a first standby component with a first version of a software program, a third active component with a second version of a software program and a fourth standby component with a second version of the software program, according to an embodiment of the present invention.

FIG. 7 is a block diagram illustrating a sixth system state with a third active component with a second version of a software program and a fourth standby component with a second version of the software program, according to an embodiment of the present invention.

FIG. 8 is a block diagram illustrating a seventh system state with a third standby component with a second version of a software program and a fourth active component with a second version of the software program, according to an embodiment of the present invention.

FIG. 9 is a block diagram of an information processing system useful for implementing an embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one, or more than one. The term “plurality,” as used herein, is defined as two, or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, an object code, a shared library/dynamic load library and/or other sequence of instructions designed for execution on a computer system. A component may include a computer program, software application, or one or more lines of computer readable processing instructions.

The present invention, according to an embodiment, overcomes problems with the prior art by providing an in-service software upgrade scheme that maintains a functional standby component during upgrade procedures so that the window of system fault vulnerability is zero.

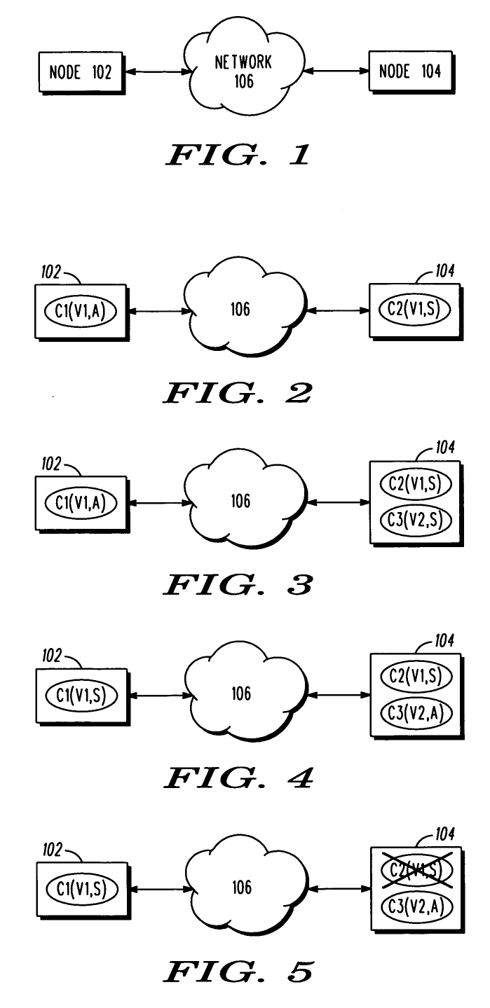

Described now is an exemplary hardware platform according to an exemplary embodiment of the present invention. FIG. 1 is a block diagram showing a high-level network architecture of one embodiment of the present invention. A first node 102 and a second node 104 are connected to a network 106. Nodes 102 and 104 can be applications, portions of a larger application, computers running applications, or any other information processing systems capable of executing applications. In an embodiment of the present invention, nodes 102 and 104 can comprise any commercially available computing system that can be programmed to offer the functions of the present invention. In another embodiment of the present invention, node 104 can comprise a client computer running a client application that interacts with a node 102 as a server computer in a client-server relationship.

In an embodiment where nodes 102 and 104 are applications or portions of applications, the nodes can be implemented as hardware, software or any combination of the two. The applications or portions of applications can be located in a distributed fashion in both nodes 102 and 104, as well as other nodes. In this embodiment, the applications or portions of applications of nodes 102 and 104 operate in a distributed computing paradigm.

In an embodiment of the present invention, the computer systems of the nodes 102 and 104 are one or more Personal Computers (PCs) (e.g., IBM or compatible PC workstations running the Microsoft Windows operating system, Macintosh computers running the Mac OS operating system, or equivalent), Personal Digital Assistants (PDAs), hand held computers, palm top computers, smart phones, game consoles or any other information processing devices. In another embodiment, the computer systems of the nodes 102 and 104 are a server system (e.g., SUN Ultra workstations running the SunOS operating system or IBM RS/6000 workstations and servers running the AIX operating system). In yet another embodiment, the nodes 102 and 104 are each a “communications server,” which is a new category of computer that has emerged over the last few years. New and emerging industry standards, such as MicroTCA, AdvancedTCA, Carrier-Grade Linux, and Service Availability™ Forum, now make it possible to build standards-based communications servers that address a wide range of applications. A communications server differs from the traditional enterprise server in a number of important ways. An enterprise server architecture is optimized to run enterprise applications in a three tier data center environment and consists of a number of similar general purpose processing or server blades sharing a common chassis, power supplies etc. A communications server architecture is optimized to provide a converged platform to run control plane, data plane and adjunct packet based service applications so, in addition to general purpose processors, it incorporates specialized multi-media processing blades and routing/packet processing blades. It can also support a wide range of specialized communications interfaces for wireless, wireline and packet networks.

In an embodiment of the present invention, the network 106 is a packet switched network. The packet switched network is a wide area network (WAN), such as the global Internet, a private WAN, a local area network (LAN), a telecommunications network or any combination of the above-mentioned networks. In yet another embodiment, the network 106 is a wired network, a wireless network, a broadcast network or a point-to-point network. In another embodiment, the network 106 is a circuit switched network, such as the Public Service Telephone Network (PSTN).

It should be noted that although nodes 102 and 104 are shown as separate entities in FIG. 1, the functions of both entities may be integrated into one system that is formed by two or more computing environments. It should also be noted that although FIG. 1 shows only two nodes, the present invention supports any number of nodes.

Referring now to FIG. 2, the nodes 102 and 104 are shown with components C1 and C2 installed. The components C1 and C2 represent the same functional software components, but are not necessarily identical. Specifically, the components, as will be explained below, can be of differing versions of a set of computer readable instructions or a computer program. In the figure, parenthesis after the component indicator is a version indicator. Throughout this specification, V1 will represent version 1 and V2 will represent version 2. Also within the parenthesis, and following the version number, is a status indicator, S or A. S indicates a standby mode and A represents an active mode. A component is considered to be in the active mode when it is actively processing system requests. A component is considered to be in the standby mode when it is not processing system requests. A component in the standby mode does, however, monitor state information of the active component.

In the initial stage, shown in FIG. 2, the component C1 resides on node 102 and component C2 resides on node 104. As indicated in the figure, both components are the original version of the software, V1. Component C1 is the active component A and component C2 is in a standby mode S. C2 dynamically synchronizes with the active component C1 on node 102 through the network 106. The synchronization allows C2 to track configurations and state information of the active component C1. While in standby mode, C2 does not process any requests.

In accordance with the present invention, as shown in FIG. 3, a third component C3 is instantiated on the second node 104. In practice, however, it is not necessary that C3 be installed on the second node. C3 can be installed on any node that is in communication with the first and second node. To eliminate fault vulnerability however, the third component will not be installed on the same node as the currently active component C1.

The third component C3, as indicated in FIG. 3, is the updated version V2 and is initially in a standby mode S. After being instantiated, C3 synchronizes with the active component C1 on node 102 through the network 106. The synchronization insures that C3 is ready to accept control and become the active component. However, while in standby mode, C3 does not process any requests.

After C3 is properly synchronized, a switch-over operation is performed. At the end of this step, as shown in FIG. 4, the first component C1 is at the original version V1 and is in standby mode S; the second component C2 is at the original version V1 and is in standby mode S; and the third component C3 is at the new version V2 and is the active A component running the system. If a fault were to occur during the switch-over operation, either component C1 or C2 is able to take over and become the active component running the original version of the software. At all times, C1 and C2 remain synchronized with the latest state information on C3 so that C1 and C2 are properly able to assume control of the system.

Next, as shown in FIG. 5, after the third component C3 becomes the active component, the second component C2 is no longer needed and is removed. The first component C1, which has the same original version V1 of the software as the second component C2, will now provide backup protection for the system.

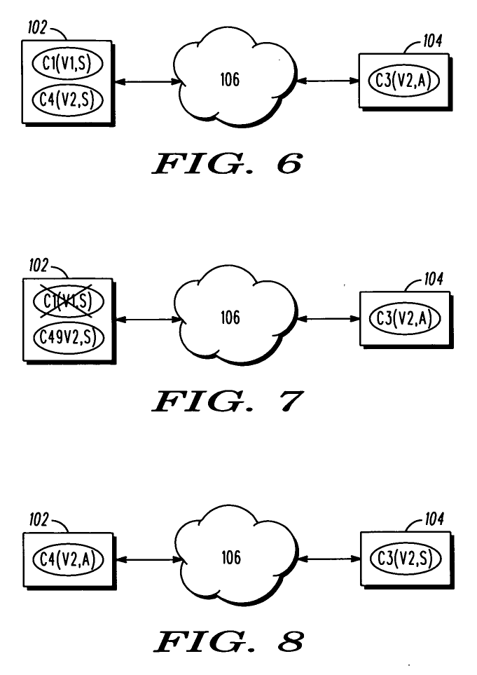

In the next step, as shown in FIG. 6, while C3 remains the active component, a fourth component C4, having the newest version of the software V2, is instantiated on the first node 102. In the interest of the highest availability, it is preferred that the new component C4 does not immediately transition to the active state (i.e., it shouldn't “wipe out” all known state information). Instead, the fourth component C4 initiates in a standby mode and immediately begins synchronizing itself with the active component C3 running version V2.

Because the newly installed fourth component C4, once synchronized, is now assuming the backup role, the first component C1 is no longer needed and is removed in a following step, shown in FIG. 7.

Next, as shown in FIG. 8, control switches from the third component C3 to the fourth component C4. The result is that the first node 102 has a component C4 running the newest version of the software and the second node 104 has a backup standby component C3, also with the latest version of the software. At no point in the update process was the system exposed to vulnerability caused by a fault. The system is continuously supported by a synchronized standby backup module that is able to assume control immediately upon detection of a failure of the active component. However, in alternative embodiment, C3 continues to be the active component and C4 exists as the backup to C3. In one embodiment, the first component C1 is not removed until control has properly switched from the third component to the fourth component.

It should be noted that in some cases, there is no state information to be synchronized between the active and standby components. In another embodiment of the present invention, the state information is maintained by a separate software program such as a database which also replicates the states on other nodes in the network. Therefore, direct communication/synchronization between the active and standby components would not be necessary.

The present invention can be realized in hardware, software, or a combination of hardware and software. A system according to a preferred embodiment of the present invention can be realized in a centralized fashion in one computer system that is capable of maintaining at least two distinct processing environments. The system can also be arranged in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

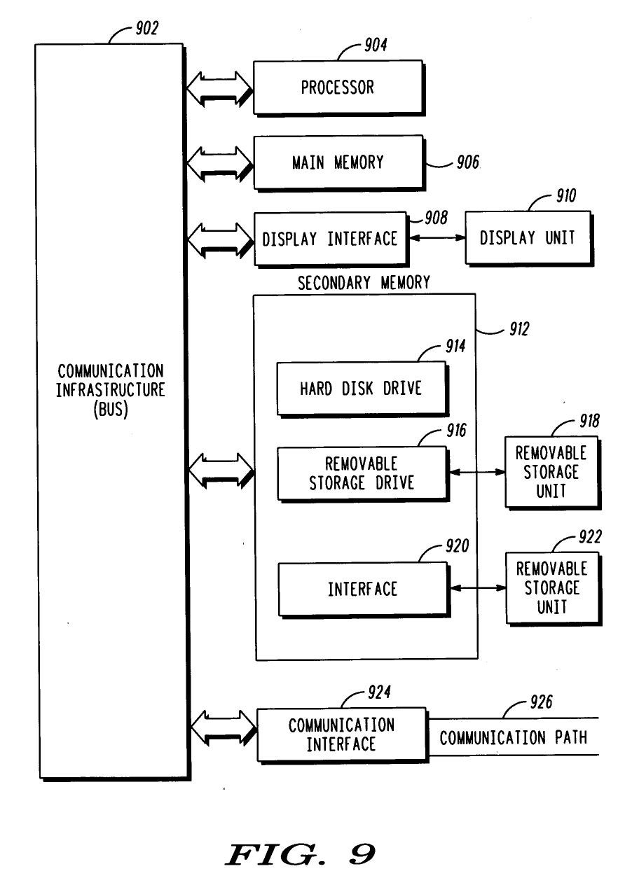

FIG. 9 is a high level block diagram showing an information processing system useful for implementing one of the nodes 102 or 104 of the present invention. The computer system includes one or more processors, such as processor 904. The processor 904 is connected to a communication infrastructure 902 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 908 that forwards graphics, text, and other data from the communication infrastructure 902 (or from a frame buffer not shown) for display on the display unit 910. The computer system also includes a main memory 906, preferably random access memory (RAM), and may also include a secondary memory 912. The secondary memory 912 may include, for example, a hard disk drive 914 and/or a removable storage drive 916, representing a floppy disk drive, a magnetic tape drive, an optical disk drive, etc. The removable storage drive 916 reads from and/or writes to a removable storage unit 918 in a manner well known to those having ordinary skill in the art. Removable storage unit 918, represents a floppy disk, a compact disc, magnetic tape, optical disk, etc. which is read by and written to by removable storage drive 916. As will be appreciated, the removable storage unit 918 includes a computer readable medium having stored therein computer software and/or data. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer-readable information.

In alternative embodiments, the secondary memory 912 may include other similar means for allowing computer programs or other instructions to be loaded into the computer system. Such means may include, for example, a removable storage unit 922 and an interface 920. Examples of such may include a program cartridge and cartridge interface (such as that found in video game devices), a removable memory chip (such as an EPROM, or PROM) and associated socket, and other removable storage units 922 and interfaces 920 which allow software and data to be transferred from the removable storage unit 922 to the computer system.

The computer system, in this example, includes a communications interface 924 that allows software and data to be transferred between the computer system and external devices or nodes via a communications path. Examples of communications interface 924 may include a modem, a network interface (such as an Ethernet card), a communications port, a PCMCIA slot and card, etc. Software and data transferred via communications interface 924 are in the form of signals which may be, for example, electronic, electromagnetic, optical, or other signals capable of being received by communications interface 924. These signals are provided to communications interface 924 via a communications path (i.e., channel) 926. This channel 926 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 906 and secondary memory 912, removable storage drive 916, a hard disk installed in hard disk drive 914, and signals. These computer program products are means for providing software to the computer system. The computer readable medium allows the computer system to read data, instructions, messages or message packets, and other computer readable information from the computer readable medium.

Computer programs (also called computer control logic) are stored in main memory 906 and/or secondary memory 912. Computer programs may also be received via communications interface 924. Such computer programs, when executed, enable the computer system to perform the features of the present invention as discussed herein. In particular, the computer programs, when executed, enable the processor 904 to perform the features of the computer system. Accordingly, such computer programs represent controllers of the computer system.

What has been shown and discussed is a highly-simplified depiction of a programmable computer apparatus. Those skilled in the art will appreciate that other low-level components and connections are required in any practical application of a computer apparatus.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for upgrading a software program, the method comprising:
installing a first component running a first version of a software program in an active mode;
installing a second component running the first version of the software program in a standby mode;
installing a third component running a second version of the software program in a standby mode;
synchronizing state information of the first component with the third component;
switching the third component to an active mode and the first component to a standby mode after the state information of the first component is at least partially synchronized with the third component;
removing the second component;
installing a fourth component running the second version of the software program in a standby mode; and
synchronizing state information of the third component with the fourth component;
removing the first component.

2. The method according to claim 1, further comprising:
switching the fourth component to an active mode and the third component to a standby mode after the state information of the third component is at least partially synchronized with the fourth component.

3. The method according to claim 1, wherein the first component is installed on a first node in a network having at least a first and a second node.

4. The method according to claim 3, wherein the second component is installed on a second node in the network.

5. The method according to claim 1, wherein the third component is installed on a second node in a network having at least a first and a second node.

6. The method according to claim 1, wherein the fourth component is installed on a first node in a network having at least a first and a second node.

7. The method according to claim 1, wherein the state information includes at least one value in at least one memory location.

8. The method according to claim 1, wherein the standby mode is a mode of operation where the component monitors state values of at least one other component.

9. A computer program product for upgrading a software program, the computer program product comprising:
a storage medium readable by a processing circuit and storing instructions for execution by the processing circuit for performing a method comprising:
installing a first component running a first version of a software program in an active mode;
installing a second component running the first version of the software program in a standby mode;
installing a third component running a second version of the software program in a standby mode;
synchronizing state information of the first component with the third component;
switching the third component to an active mode and the first component to a standby mode after the state information of the first component is at least partially synchronized with the third component;
removing the second component;
installing a fourth component running the second version of the software program in a standby mode;
synchronizing state information of the third component with the fourth component; and
removing the first component.

10. The computer program product according to claim 9, further comprising:
switching the fourth component to an active mode and the third component to a standby mode after the state information of the third component is at least partially synchronized with the fourth component.

11. The computer program product according to claim 9, wherein the first component is installed on a first node in a network having at least a first and a second node.

12. The computer program product according to claim 11, wherein the second component is installed on a second node in the network.

13. The computer program product according to claim 9, wherein the third component is installed on a second node in a network having at least a first and a second node.

14. The computer program product according to claim 9, wherein the fourth component is installed on a first node in a network having at least a first and a second node.

15. The computer program product according to claim 9, wherein the state information includes at least one value in at least one memory location.

16. The computer program product according to claim 9, wherein the standby mode is a mode of operation where the component monitors state values of at least one other component.

17. A method for upgrading a software program in a multi-node network, the method comprising:
installing a third component running a second version of a software program in a standby mode on a second node of a multi-node network, the second node having a second component running a first version of the software program in a standby mode;
synchronizing state information of a first component running a first version of a software program in an active mode on a first node within the multi-node network with the third component;
switching the third component to an active mode and the first component to a standby mode after the state information of the first component is at least partially synchronized with the third component;
removing the second component from the second node;
installing a fourth component running a second version of the software program in a standby mode on the first node; and
synchronizing state information of the third component with the fourth component;
removing the first component from the first node.

18. The computer program product according to claim 17, further comprising:
switching the fourth component to an active mode and the third component to a standby mode after the state information of the third component is at least partially synchronized with the fourth component.

19. The method according to claim 17, wherein the state information includes at least one value in at least one memory location.

20. The method according to claim 17, wherein the standby mode is a mode of operation where the component monitors state values of at least one other component.
